(19) United States
(12) Patent Application Publication
(10) Pub. No.: US 2004/0122951 A1
(43) Pub. Date: Jun. 24, 2004

(54) Method and apparatus for providing Web users with a click-to-contact service

(76) Inventors: Andre Beck, Woodbridge, NJ (US); Volker Hilt, Middletown, NJ (US); Markus Andreas Hofmann, Fair Haven, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/322,679

(22) Filed: Dec. 18, 2002

(51) Int. Cl. G06F 15/16

(52) U.S. Cl. 709/227; 709/217

(57) ABSTRACT

A click-to-contact service automatically and uniformly converts all types of contact information embedded in any Web page into click-to-contact links. This user-oriented service is realized with a click-to-contact agent, which takes any Web page as an input and adds click-to-contact links to the contact information located within that Web page. This agent can be invoked from the Web browser running on an end-user's client system or from within the network. This click-to-contact agent performs the tasks of searching an incoming Web page for contact information by applying a grammar for such contacts. When contact information is found, the Web page is modified to include a link in association with that contact information within the Web page. When the end-user subsequently clicks on or otherwise selects such a click-to-contact link, one or two-way telephonic or electronic communication is established between the end-user and an address associated with the contact information within the Web page.

### TECHNICAL FIELD

This invention relates to retrieving a Web page over the Internet and, more specifically, to establishing communication with a point of contact that is mentioned within the content of that page.

### BACKGROUND OF THE INVENTION

The World Wide Web has become a major source of information to end-users. Many companies ranging from small businesses to large enterprises offer a large variety of information on their Web site's Web pages. These Web sites can be publicly available, targeted mainly at customers and business partners, or they can be internal and targeted mainly at employees, service representatives, or “road warriors”. Many of these Web sites provide information on their Web pages for enabling the end-user to contact an individual or an organization within the Web site proprietor's domain. Such a contact can be a name and an associated street address, an email address, an Instant Messaging address, an SIP address, or, most important, a telephone number. If an end-user wants to make use of the contact information provided on the Web page, he has to manually transfer the provided contact information from the Web browser to another application or device (e.g., a telephone). Additionally, if only a name and address is provided in the Web page, the end-user must first look-up other contact information, such as a telephone number, before placing the telephone call. This manual transfer of information between a Web browser and a different application or device is not only inconvenient but also error prone. Furthermore, it can result in a substantial waste of time, especially if an end-user has to look up contacts from different Web pages many times a day.

Various click-to-dial solutions are currently available that enable an end-user to click on a link on a Web page and establish a telephone call between a telephone number associated with the point of contact on the Web page and the end-user's own telephone. These click-to-dial solutions require the content provider's cooperation in that the Web page must be pre-configured by the creator of the Web page to include one or more of these links, and such links are limited to telephone numbers. In any of these click-to-dial systems, a content provider, such as the operator of a directory service, must explicitly add click-to-dial links to the phone numbers noted in their Web page. When an end-user at a client clicks on such a link on a Web page, the end-user's browser forwards a request to a click-to-dial server, which upon receiving the request sets up a phone call between the end-user and the link target. Generally, in these click-to-dial systems, the click-to-dial server determines the end-user's telephone number from, for example, a cookie in the request. The server then sets up phone connections on the POTS (Plain Old Telephone Service) network or over an IP network to the end-user's telephone and to the phone number of the contact that is associated with the URL of the link, and establishes a bridge between both such telephone connections to enable the end-user to communicate with the contact.

In many cases, Web pages with contact information are generated automatically, for example from a directory. In these cases, the page generator adds the click-to-dial links to the generated Web pages.

The common principle behind all current click-to-dial solutions is that click-to-dial links are inserted on the server side by the creator of a Web page or by a page generator. Inherent to this principle is that the Web site operator must support a click-to-dial service in order to make it available to an end-user. The Web site operator also must choose from the different click-to-dial solutions that are available, each of which having specific advantages and disadvantages.

### SUMMARY OF THE INVENTION

In accordance with the invention, a click-to-contact service automatically and uniformly converts all types of contact information embedded in any Web page into click-to-contact links. This end-user-oriented service is realized with a click-to-contact agent, which takes any Web page as an input and adds click-to-contact links to the contact information located within that Web page. This agent can be invoked from the Web browser running on an end-user's client system or from within the network. This click-to-contact agent performs the tasks of searching an incoming Web page for contact information by applying a grammar for such contact information. When contact information is found, the Web page is modified to include a link in association with that information within the page. When the end-user subsequently clicks on or otherwise selects such a click-to-contact link, one or two-way telephonic or electronic communication can be instantly established between the end-user and the address associated with the selected contact information. If the contact information is an address of the type that can used to establish telephonic or electronic communication, then by selecting the link communication between the end-user and the contact at that address is facilitated. If the click-to-contact service cannot uniquely identify the telephonic or electronic address of the contact from the contact information contained in the Web page (e.g., if the contact information consists only of a name and address), then a choice of different contact addresses that are associated with the contact information in the Web page can be provided to the user to select from. Also, the service may prompt the end-user to determine and then select from various ways of contacting the selected contact, such as by phone, by instant messaging, by email, or by other means.

In a first embodiment, the click-to-contact service is provided through a software module through an end-user's browser that can be invoked whenever the Web browser loads a Web page. Alternatively, the click-to-contact functionality could be provided through JavaScript code that is contained within a browser bookmark, such that when the end-user invokes this bookmark from a given Web page, the JavaScript code contained within the bookmark obtains access to the properties of the Web page and detects and converts the contact information contained within the Web page into click-to-contact links.

In a second embodiment, an intermediary network element in the path between the Web server and the end-user's client, intercepts or otherwise receives all HTTP requests and responses that are exchanged between a Web server and the end-user's browser. In this embodiment, the intermediary receives the HTTP response containing a Web page and, using a grammar, detects and converts the contact information within the page into click-to-contact links, thereby modifying the Web page as the page is forwarded to the end-user's browser.

### BRIEF DESCRIPTION OF THE DRAWING

FIG. 1 is a block diagram of a system architecture that uses a embodiment of the invention in which the click-to-contact agent functionality is incorporated within an end-user's browser;

FIG. 2 is a flowchart showing the steps of the present invention associated with the embodiment in FIG. 1;

FIG. 3 is a block diagram of a system architecture that uses an embodiment of the invention in which the click-to-contact functionality is incorporated within an intermediary within the network;

FIG. 4 is a block diagram of the service platform architecture of an embodiment of the intermediary device in FIG. 3; and

FIG. 5 is a flowchart showing the steps of the present invention associated with the embodiment in FIG. 3.

### DETAILED DESCRIPTION

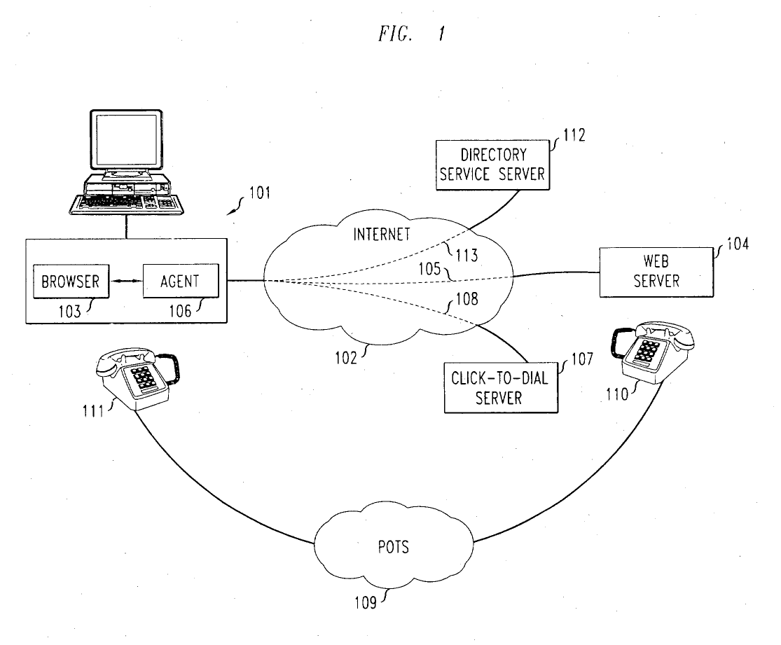

In the browser-enabled embodiment of the invention, with reference to FIG. 1, a client 101 is shown connected to the Internet 102. The client 101 can be connected to the Internet in various ways, such as through the POTS network using a standard voice-band modem, over a DSL connection through the local telephone company, over a cable-TV connection using a cable modem, over a wireless connection, or any other wired or wireless arrangement. The client 101 can be any type of client including, for example, a standard computer terminal, a PDA, an Internet-enabled cellular telephone, or any other type of client device. The client 101 runs a conventional browser program 103 appropriate for its client type.

When the client's browser 103 issues a request of a URL at a Web server 104 for a Web page of a type appropriate for the type of client on which the browser is running, that Web page is downloaded by server 104 through the Internet 102 to browser 103 in the form of a response to the request. The pathway of that request and the associated response are noted in FIG. 1 by the dotted connection 105 through Internet 102 between client 101 and Web server 104. The content of the requested Web page may include one or more pieces of information that represent an address for communicating with a point of contact with which or with whom the end-user may be desirous of interacting, or which in some other way represent a particular point of contact. In the prior art, as described above, for a click-to-dial service, the creator of the Web page had to construct the page so as to incorporate associated links to addresses of selected points of contact noted on the page. In the present invention, any Web page that is downloaded by an end-user can be automatically modified to associate links with addresses of potential points of contact with which or whom the end-user can establish communication by selecting that link. To that end, a downloaded Web page is analyzed using a grammar to determine within that page what might be an address of a point of contact that should be associated with a link. The potential point of contact information included in the Web page can be, for example, but are not limited to, a name and street address, a phone number, an email address, an Instant Messaging address, an SIP address, or any other identification of a potential communication endpoint.

In the first embodiment of the invention in FIG. 1, an agent module 106 is associated with the end-user's browser 103. That agent module 106, an extension of the browser 103, is invoked each time a Web page is played. The agent module 106 performs the functions of searching the content of the Web page, using a grammar to determining point of contact information, and modifying the Web page to include a link to effect communication with that point of contact. Such a grammar defines what a particular type contact information looks like and what a particular type of contact information doesn't look like. With respect to phone numbers, for example, the agent module 106 may look for a sequence of ten digits separated in some manner (such as a hyphen, a space, a comma, a parenthesis) into two consecutive groups of three digits, and a third group of four digits, or one group of three digits separated in some manner from a second group of seven digits, or an uninterrupted sequence of ten digits. A phone number would not consist of a sequence of only six numbers, for example. In a similar manner, email addresses, instant messaging addresses or SIP addresses can be located by their unique characteristics, such as, for an email address, the inclusions of an “@” within a continuous alphanumeric sequence. A name and its associated street address could also be located within a Web page by using a grammar that uniquely defines the characteristics of an associated name and street address. Creating a grammar that defines what phone numbers, email addresses, instant messaging addresses, SIP addresses, names and associated street addresses, etc. look like and don't look like in a Web page is within the capabilities of one skilled in the art.

When the agent module 106 identifies point of contact information within a Web page, a link is created on the Web page in association with that information. If the contact information is of a type sufficient to instantly reach the identified point contact such as, for example, a telephone number, an email address, or an SIP address, then when the end-user clicks or otherwise selects that link, a connection is automatically established to, for example, a particular click-to-dial service provider's Web site. Thus, if the identified contact information is a telephone number, a link is created on the Web page to a click-to-dial service provider's server shown in FIG. 1 as server 107. In response to the end-user's selecting that link, a request is issued by browser 103 to server 107, shown illustratively in FIG. 1 as the dotted connection 108 between client 101 and server 107. The URL of that request identifies to server 107 the telephone number identified within the Web page. The end-user's own telephone number is identified to server 107 by means of, for example, a cookie included in the request. In response to the request, server 107 establishes a telephonic connection over the POTS network 109 to the telephone 110 associated with the point of contact of Web server 104, and to the end-user's telephone 111, which two connections are then bridged allowing the end-user to communicate with the Web server's point of contact. As an alternative to creating a link to a click-to-dial server, a link can be created that when selected by the end-user, the agent will directly initiate a phone call between a telephone connected to the user's client and the identified contact telephone number.

If, rather than identifying a telephone number in the retrieved Web page, agent 106 identifies an email address, an Instant Messaging address, or an SIP address, or other instantly contactable address, then in response to the end-user selecting the associated link on that Web page, browser 103 could automatically open an appropriate window within which the end-user can create a message for forwarding to the address identified within the Web page, or for the SIP address example, could establish communication directly using a SIP user agent running on the end-user's client or on a separate device.

Optionally, the agent software can be designed so that the link created in association with an identified point of contact information within a Web page (e.g., name and address, phone number, email address, etc.), can be to a directory service running on a server 112. The identified point of contact information is then provided to that directory server 112 when the end-user selects that link. In response to that selection, directory service server 112 then returns to browser 103 what might be multiple addresses for electronically or telephonically communicating with the identified contact, such as, for example, a telephone number, an email address, an Instant Messaging, or an SIP address. The dotted connection 113 between client 101 and directory server 112 illustrates the request and response between each of these endpoints. The agent 106, upon receiving from the directory service server 112 these multiple addresses for electronically or telephonically establishing communication with the point of contact, assigns a link to each and opens a new HTML window in the end-user's browser containing each address with an associated link. The end-user, by selecting one such link establishes telephonic or electronic communication with the point of contact at the address associated with the selected link. Thus, for example, if the point of contact information in the retrieved Web page is a name and address, that information is provided to the directory service server 112 when the end-user selects the link associated with the name and address in the modified Web page. If determinable, the directory service server will responsively provide one or more of a phone number, an email address, an Instant Messaging address, an SIP address, etc., associated with that name and address. Upon receiving this information from the directory service server, the agent opens a new window that provides the end-user with the option to choose, by selecting a link, how to establish communication with the point of contact. For example, by selecting a link associated with the point of contact's telephone number, the click-to-dial server 107 is contacted to establish telephonic communication. Similarly, by selecting a link associated with an email address, another window is opened to facilitate sending an email message to the point of contact's email address.

As an additional option, the agent software can be configured so that when point of contact information identified within a Web page is of a type that can be directly reached telephonically or electronically, such as a telephone number, an email address, an Instant Messaging address, or an SIP address, then the link created on the modified Web page, when selected by the end-user, facilitates communication between the end-user and that point of contact address. However, when the end-user right clicks on his mouse, for example, the end-user is presented with the option to determine other ways of telephonically or electronically reaching the point of contact. If selected by the end-user, a request is sent to directory service server 112 to determine these other telephonic or electronic addresses that are associated with the point of contact information contained within the Web page. For example, if the information within the Web page is a telephone number, by selecting this option, that telephone number is provided to the directory service server, which might responsively return, for example, an email address, and Instant Messaging address, and/or an SIP address that are all also associated with that same point of contact. The end-user then has the option of establishing communication using a click-to-dial connection to the telephone number within the page, or using the email address, Instant Messaging address, or the SIP address determined by the directory service server. If the information within the Web page is insufficient to establish telephonic or electronic communication, such as a name and address absent a phone number, then the end-user, by necessity, would need to select the directory service server option in order to determine an associated telephonic or electronic addresses.

As described above, the agent 106 is invoked whenever Web browser 103 loads a Web page. Other click-to-contact specific commands, such as the option to add the selected contact information to the end-user's address book, could be added to the browser's context menu or toolbar. The software module that provides the agent's functionality that extends the browser's standard functionality could be automatically distributed to end-users via Web pages. Such click-to-contact functionality could also be provided to end-users through a click-to-contact Web object, which is able to access and modify the properties of different Web objects when invoked by the end-user. Specifically, the click-to-contact functionality could be provided through JavaScript code contained with a browser bookmark. Such a bookmark can be distributed to end-users via a Web page. When the end-user invokes the click-to-contact bookmark from a given Web page, then the click-to-contact JavaScript code contained within the bookmark obtains access to the properties of the Web page for detecting and converting contact information contained with the content of the Web page into click-to-contact links.

Additional click-to-contact functionality, such as the ability to add identified contact information to the end-user's address book, could be provided through the modification of Web pages, e.g. through the insertion of additional links.

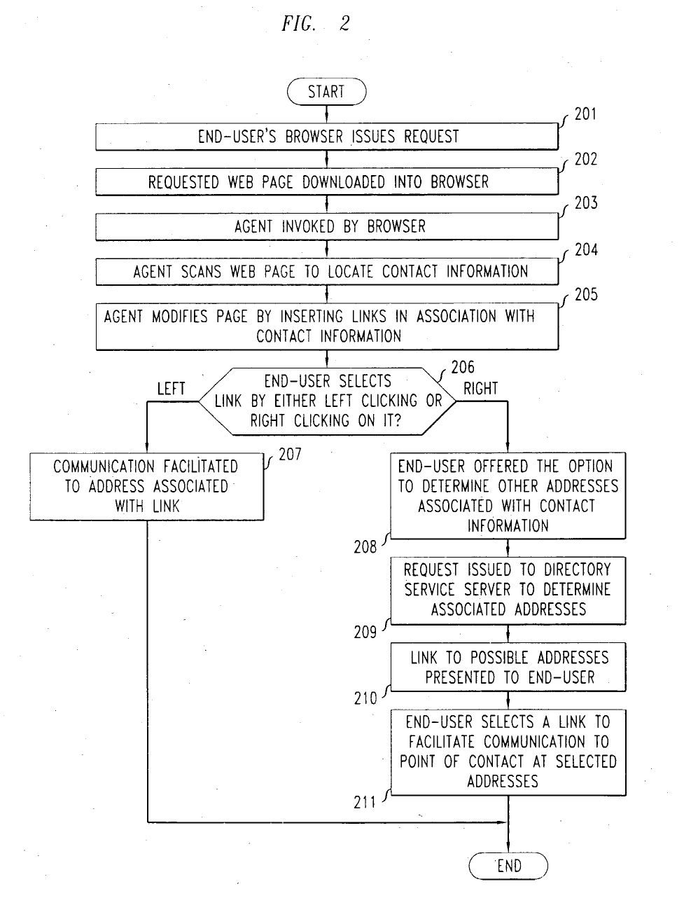

The flowchart in FIG. 2 summarizes the steps of the afore-described first embodiment of the invention. At step 201, in response to the end-user's input, the end-user's browser issues a request for a Web page. At step 202, the requested Web page is downloaded into the end-user's Web browser. At step 203, the browser invokes the agent either automatically or by action of the end-user. Advantageously, in this embodiment, the requested Web page can be displayed in the browser enabling the end-user to peruse the page as, in step 204, the agent scans the page and determines, using a grammar, potential point of contact information. At step 205, links to those determined points of contact are determined and added to the displayed and modified Web page. Optionally, the entire Web page may be modified and presented to the end-user only after all point of contact information has been determined and corresponding links added to the page. For illustrative purposes, the flowchart assumes the above-described option that allows access to a directory service server to determine whether other addresses are associated with the point of contact information within the page. At step 206, therefore, the end-user has the option of left-clicking on the link to effect immediate connection to the point of contact at the address located within the Web page, or of right clicking on the same link to determine what, if any, other addresses may be associated with that same point of contact information through which communication with that same point of contact can be effected. If the end-user left-clicks on the link within the modified page, then, at step 207, communication is facilitated to the address associated with the selected link, such as via a click-to-dial server, or via opening an email window for email communication. If, at step 206, the end-user right clicks on the link on the modified Web page, then, at step 208, a new window is opened in which the end-user is offered the option to determine other addresses that might be associated with the point of contact information located within the Web page. If the end-user selects to determine other addresses, then, at step 209, the end-user's browser issues a request to a directory service server to determine which other addresses are associated with the point of contact information within the Web page. At step 210, links to all possible addresses for communicating with the point of contact are presented in the window to the end-user. If no such information is available from the directory service server about the requested contact, the directory server will return a message indicating this (not shown). At step 211, the end-user selects one of these links to facilitate communication to the point of contact at the address associated with the selected link.

In a second embodiment of the invention, the browser does not invoke the agent. Rather, a click-to-contact functionality is added to a retrieved Web page through the intermediation of HTTP traffic. This intermediation is performed by what is referred to as a “Web intermediary,” which is located in the data path between the end-user's client and the Web server that is accessed by the browser running on the client, and which can intercept or otherwise receive all HTTP requests and responses that are exchanged between the Web server and the browser. Such a Web intermediary is described by Andre Beck and Markus A. Hofmann, two of the co-inventors of the present invention, in an article entitled “Enabling the Internet to Deliver Content-Oriented Services,” Proceedings of Sixth International Workshop on Web Caching and Content Distribution (WCW), Boston, Mass., Jun. 20-22, 2001, which is incorporated by reference herein. That article describes in detail a service platform architecture that extends the existing network edge infrastructure towards a flexible and open platform for a variety of new content services. This platform makes use of and extends existing intermediary devices, such as caching proxies and content-aware switches, enabling them to perform specific tasks on the application-layer content that is routed through them. That intermediary device is also described by the same two afore-noted co-inventors in a co-pending patent application Ser. No. 10/135,920 filed on Apr. 30, 2002, also incorporated by reference herein. In that co-pending application, the intermediary is used for providing additional intelligent value-added services by operating on a request and its response message stream passing through it going to and coming from a content provider's server so as to determine from the content of a response to a request whether additional context-specific information should be made available to the user when the requested response is delivered to the user's client.

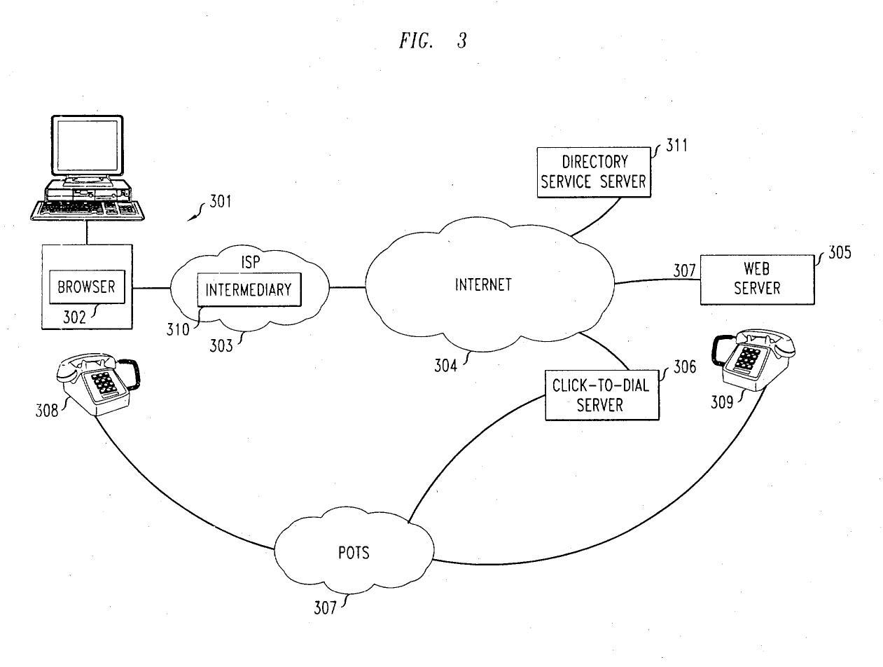

For purposes of the present invention, an intermediary through which all Web traffic passes can be located in a proxy within an enterprise network to which the end-user is connected, such as a private corporate network. Alternatively, the intermediary can be located at the edge of the end-user's ISP through which all of the end-user's requests and responses pass. In the embodiment shown in FIG. 3, the intermediary is shown located, for illustrative purposes, at the edge of the end-user's ISP network.

With reference to FIG. 3, the end-user's client 301, running a browser 302, is connected through its ISP 303 to the Internet 304. Intermediary 310 intercepts all HTTP requests issued by browser 302 that are directed to any Web server, such as Web server 305. Similarly, intermediary 310 receives or otherwise intercepts all responses to such requests from all Web servers, such as Web server 305, that are directed to the end-user's browser 302. Specifically, intermediary 310 performs the functions of: (1) intercepting all responses to requests received from Web servers; (2) determining whether the response is a Web page of the type that should be modified with the inclusion of point of contact links; (3) if it is such as response, using a grammar to detect contact information contained within the Web page; (4) modifying the Web page by converting such point of contact information into click-to-contact links on the Web page; and (5) forwarding the modified Web page to the end-user's browser 302.

Unlike the first described embodiment in which links can be added to the contact information within the page as the Web page is being processed by the agent while the unmodified page is being viewed by the end-user in his browser, in this embodiment the intermediary processes the Web page on the fly as the Web page passes through it, and modifies the page by adding links where it determines contact information to be. The modified Web page is thus forwarded to the end-user's browser 302 as it is being processed.

As the agent module 106 performs in the first described embodiment, when intermediary 310 identifies contact information within a Web page Web, it creates a link on that Web page, if the Web page is from a Web server, such as Web server 305, for which it is to perform this functionality. If the contact information within the Web page is of a type sufficient to instantly establish communication with the identified point of contact, such as a telephone number, then the end-user, by clicking or otherwise selecting the link, can establish a connection to, for example, a click-to-dial service provider's Web server 306. As previously described, when the end-user selects that link, the click-to-dial service provider's Web server 306 establishes connections over the POTS network 307 the end-user's telephone 308 and to the point of contact at telephone 309 associated with the proprietor of Web server 305. Similarly, as also previously described, if another type of instantly contactable contact information is identified, then if the end-user selects the associated link, an appropriate window is opened to allow the end-user to prepare and send a message to the identified address. Also, optionally, as previously described in conjunction with the first embodiment, intermediary 310 can be designed to automatically send a request to a directory service server 311 when the end-user selects a link associated with an identified point of contact. As previously described, this could provide to the end-user multiple ways of establishing telephonic or electronic communication with an identified point of contact. Alternatively, the link associated with an identified point of contact could be encoded so that when selected by the end-user, an additional window is opened that gives the end-user the option to either establish immediate telephonic or electronic communication with the identified point of contact by selecting a link in that newly opened window, or to send the point of contact information to directory service server 311 to locate what might be other addresses for establishing telephonic or electronic communication with the point of contact. Additional click-to-contact functionality, such as the ability to add identified contact information to the end-user's address book, could be provided through the modification of Web pages, e.g. through the insertion of additional links.

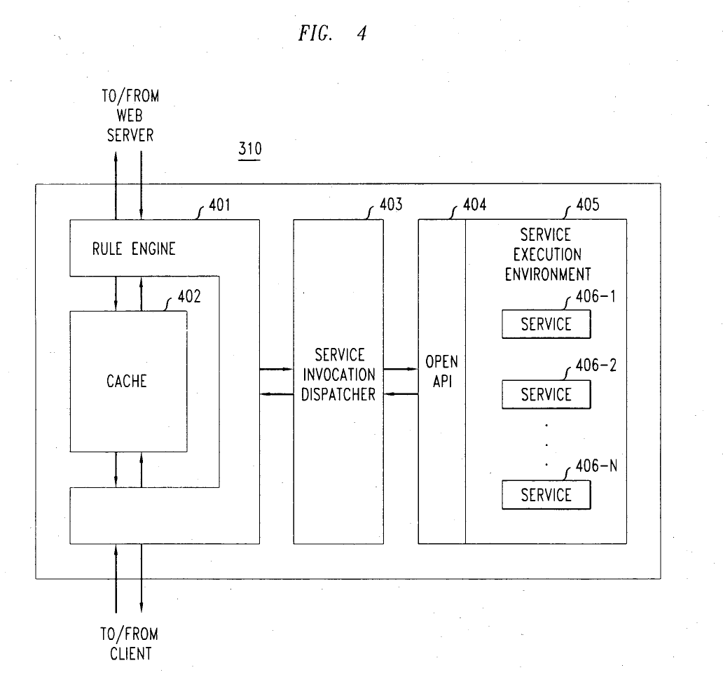

FIG. 4 shows a block diagram of an embodiment of the intermediary 310 in FIG. 3. Intermediary 310 includes a rule engine 401, a cache 402, a service invocation dispatcher 403, an open API 404, and a service execution environment 405 containing a plurality of service modules 406-1-406-N. Rule engine 401 examines each response to a request to determine whether its format is that of a Web page, and if so, based possibly on its source address, whether it is a Web page that should be processed to find contact information and add links. If the rule engine 401 determines that the response is a Web page and it is a Web page to be processed, then a contact-locating-and-link-inserting service module 406 is invoked to perform the functions of using a grammar to locate points of contact within the page, and modifying the page with the inclusion of appropriate links. Various mechanisms can be employed to determine whether the response to a request from a Web server is to be processed by the invocation of a service module. A proposed standardized Intermediary Rule Markup Language (IRML) can be used to specify rule conditions that would invoke the contact-locating-and-link-inserting service module 406. This standardized rule specification language has been proposed and submitted to the IETF standards body for the exchange of rules between rule authors and service platforms (see, e.g., A. Beck, M. Hofmann: “IRML—A Rule Specification Language for Intermediary Services”, Internet Draft, IETF, November 2001, available at http://search.ieff.org/internet-drafts/draft-beck-opes-irml-02.txt), also incorporated herein by reference The proposed standardized Intermediary Rule Markup Language is an example of a rule language that can be used and other rule languages could be devised by those skilled in the art. A standardized rule language advantageously allows rule authors to specify rules for network edge services in a standard format. Thus, if a standardized language is used, rules can be distributed to different service platforms owned by different access providers in the same standard format. IRML is an application of the Extensible Markup Language (XML). Thus, the IRML syntax is governed by the rules of the XML syntax (see, e.g., T. Bray, J, Paoli, C. M. Sperberg-McQueen, and E. Maler, “Extensible Markup Language (XML) 1.0” (Second Edition), W3C Recommendation, W3C, October 2000), which is well known to those skilled in the art, and the IRML grammar is specified by a DTD, a Document Type Definition.

When the rule engine 401 determines that the contact-locating-and-link-inserting service module 406 is to be invoked, the invoked service module 406 is provided with the Web page content. The service invocation dispatcher 403 performs these tasks. Specifically, the rule engine 401 notifies the service invocation dispatcher 403 that a particular service module 406 within the service execution environment 405 is to be invoked. Although all service modules 406 are shown to be local to the intermediary 310 in FIG. 4, it is possible that some service modules may be resident upon a dedicated service execution server, where the particular service is invoked. For this latter case, not shown in FIG. 4 but shown in the referred-to and incorporated article, the service execution dispatcher 403 differentiates between local service modules and service modules on a remote server and directs the request to the remote service execution server for processing if the invoked service module is not a local service module but is resident on the remote server

The open API (Application Program Interface) 404 provides the interface from the service invocation dispatcher 403 to the service execution environment 405 containing the plural service modules 406. After the contact-locating-and-link-inserting service module 406 locates points of contact in the Web page and modifies the page to include the appropriate links, the modified Web page is returned through the open API 404, the service invocation dispatcher 403, and the rule engine 401, and onto the Internet to the end-user's client to which it is addressed.

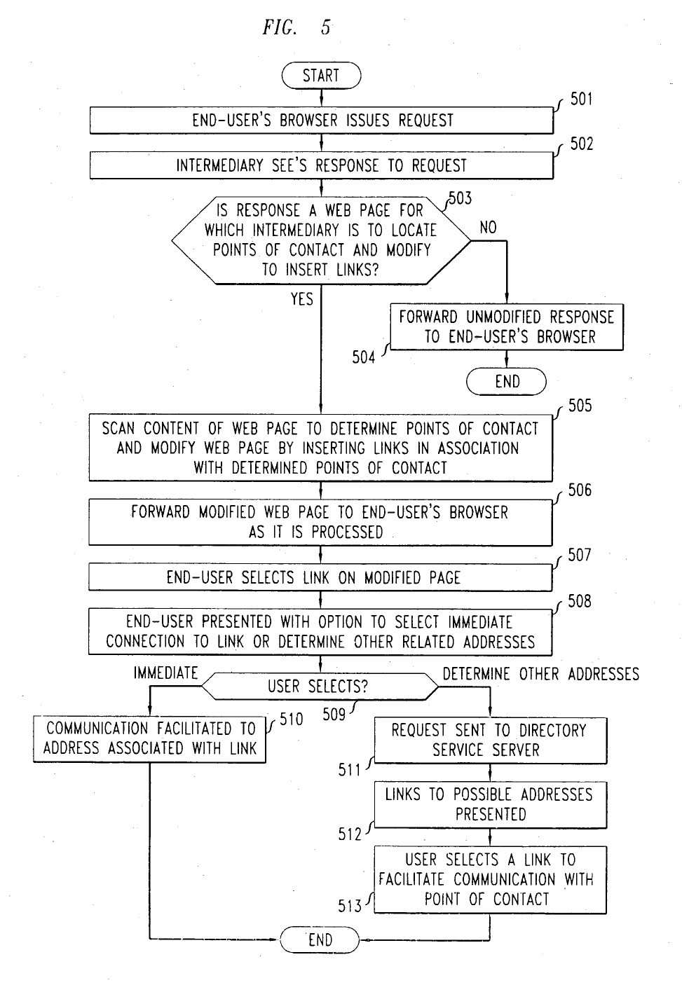

The flowchart in FIG. 5 summarizes the steps of the afore-described second embodiment of the invention. At step 501, in response to the end-user's input, the end-user's browser issues a request, which request passes through the intermediary. At step 502, the intermediary sees the response to the request. At step 503, the intermediary determines whether the response has the format of a Web page and whether the Web page is one for which its contents should be analyzed to locate contact information and modify the page by insertng links. If not, then, at step 504, the unmodified response is passed to the end-user's browser. If yes, then at step 505, the intermediary scans the content of the Web page on the fly to locate contact information as defined by a grammar, and inserts links in the Web page wherever it determines contact information to be. At step 506, as the intermediary processes the Web page, it forwards it to the end-user's browser so that it can be viewed by the end-user. At step 507, the end-user clicks or otherwise selects a link on the modified page. The afore-described option that gives the end-user the ability to determine other addresses associated with the point of contact information within the Web page is assumed for illustrative purposes of this flowchart. By selecting a link at step 507, the end-user is presented with the option, at step 508, of either establishing immediate telephonic or electronic communication with the identified point of contact via the address information within the Web page, or of sending that contact information to a directory service server to determine possible other associated point of contact addresses. If, at step 509, the end-user chooses to make an immediate connection and if the contact information within the Web page is sufficient to enable the end-user to make such a connection, then, at step 510, such communication is effected. Thus, if the information is a telephone number, a connection to a click-to-dial server is made, or if the information is an email address, for example, a window is opened to allow the end-user to input an email message. If, at step 509, the end-user chooses to determine additional contact address information, then at step 511, a request containing the known contact information is made to a directory service server. At step 512, the directory server responds with such associated contact address information and a window is opened in the end-user's browser that contains links to all the addresses to which the end-user can establish communication, including the original link to the address within the Web page and the additional addresses provided by the directory service server. If no such additional contact information is available from the directory service server, then that information is provided in the window (not shown). At step 513, the end-user selects one of these links to facilitate communication with the point of contact using the address associated with the selected link. Thus, if the address associated with the selected link is an email address, then a window is opened to allow the end-user to input an email message. If the address is a telephone number, than a connection to a click-to-dial server is effected to set up telephonic connections to that telephone number and to the end-user's telephone number.

Although the invention has been described as locating contact address information within a Web page, the grammar could be defined to locate any other type of defined information from which a point of contact address could be derived. For example, the grammar could be designed to identify employee identification numbers within a Web page from which a point of contact, such as a telephone number or an email address could be readily determined. The Web page is then modified to associate a link with that information if such a telephonic or electronic address is determined so that if the link is selected by the end-user, communication can be established between the end-user and that point of contact.

The foregoing merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be further appreciated by those skilled in the art that the block diagrams herein represent conceptual views embodying the principles of the invention. Similarly, it will be appreciated that the flowchart represents various processes that may be substantially represented in computer readable medium and so executed by a computer or processor, whether or not such computer or processor is explicitly shown.

The invention claimed is:

1. A method comprising the steps of:
receiving a Web page;
locating within the received Web page contact information associated with a point of contact; and
modifying the Web page by inserting in association with the located contact information a link which when selected by an end-user facilitates communication with the point of contact.

2. The method of claim 1 wherein the contact information is at least one of a telephone number, an email address, an Instant Messaging address, an alphanumeric name and address, and an SIP address that are associated with the point of contact.

3. The method of claim 2 wherein the information is a telephone number associated with the point of contact and the link is a link to a click-to-contact server, which when selected by the end-user establishes telephonic connections to a telephone at the telephone number associated with the point of contact and to a telephone at a telephone number associated with the end-user.

4. The method of claim 2 wherein the information is a telephone number associated with the point of contact, the link associated with the telephone number when selected by the end-user, directly establishing telephonic connections to a telephone at the telephone number associated with the point of contact and to a telephone at a telephone number associated with the end-user.

5. The method of claim 2 further comprising the steps of:
determining from the contact information at least one other address for telephonically or electronically establishing communication with the point of contact; and
creating a link to the determined other address;
wherein telephonic or electronic communication is facilitated between the end-user and the point of contact at the determined other address when the end-user selects the link to the determined other address.

6. The method of claim 5 wherein the contact information is an alphanumeric name and an address and the determined other address is at least one of a telephone number, an email address, an SIP address, and an Instant Messaging address.

7. The method of claim 5 wherein the step of determining from the contact information at least one address comprises sending the located contact information in a request to a directory service server to determine the other address.

8. The method of claim 1 wherein the method is performed by a Web intermediary.

9. The method of claim 8 wherein the step of locating contact information is performed only if the Web page is received from one of a plurality of predetermined Web servers.

10. The method of claim 1 wherein the method is performed on an end-user's client in conjunction with a browser by a software module that is invoked when the browser loads a Web page.

11. The method of claim 1 wherein the steps of locating contact information and modifying the Web page are performed by JavaScript code contained in a bookmark that is invoked by an end-user from the received Web page.

12. A computer readable media tangibly embodying a program of instructions executable by a computer to perform a method, the method comprising the steps of:
receiving a Web page;
locating within the received Web page contact information associated with a point of contact; and
modifying the Web page by inserting in association with the located contact information a link which when selected by an end-user facilitates communication with the point of contact.

13. The computer readable media of claim 12 wherein the contact information is at least one of a telephone number, an email address, an Instant Messaging address, an alphanumeric name and address, and an SIP address that are associated with the point of contact.

14. The computer readable media of claim 13 wherein the information is a telephone number associated with the point of contact and the link is a link to a click-to-contact server, which when selected by the end-user establishes telephonic connections to a telephone at the telephone number associated with the point of contact and to a telephone at a telephone number associated with the end-user.

15. The computer readable media of claim 13 wherein the information is a telephone number associated with the point of contact, the link associated with the telephone number when selected by the end-user, directly establishing telephonic connections to a telephone at the telephone number associated with the point of contact and to a telephone at a telephone number associated with the end-user.

16. The computer readable media of claim 13 wherein the method further comprises the steps of:
determining from the contact information at least one other address for telephonically or electronically establishing communication with the point of contact; and
creating a link to the determined other address;
wherein telephonic or electronic communication is facilitated between the end-user and the point of contact at the determined other address when the end-user selects the link to the determined other address.

17. The computer readable media of claim 16 wherein the contact information is an alphanumeric name and an address and the determined other address is at least one of a telephone number, an email address, an SIP address, and an Instant Messaging address.

18. The computer readable media of claim 16 wherein in the method the step of determining from the contact information at least one address comprises sending the located contact information in a request to a directory service server to determine the other address.

19. Apparatus comprising:
means for receiving a Web page;
means for locating within the received Web page contact information associated with a point of contact; and
means for modifying the Web page by inserting in association with the located contact information a link which when selected by an end-user facilitates communication with the point of contact.

20. The apparatus of claim 19 wherein the contact information is at least one of a telephone number, an email address, an Instant Messaging address, an alphanumeric name and address, and an SIP address that are associated with the point of contact.

21. The apparatus of claim 20 wherein the information is a telephone number associated with the point of contact and the link is a link to a click-to-contact server, which when selected by the end-user establishes telephonic connections to a telephone at the telephone number associated with the point of contact and to a telephone at a telephone number associated with the end-user.

22. The apparatus of claim 20 wherein the information is a telephone number associated with the point of contact, and when the link associated with the telephone number is selected by the end-user, telephonic connections are directly established to a telephone at the telephone number associated with the point of contact and to a telephone at a telephone number associated with the end-user.

23. The apparatus of claim 20 further comprising:
means for determining from the contact information at least one other address for telephonically or electronically establishing communication with the point of contact; and
means for creating a link to the determined other address;
wherein telephonic or electronic communication is facilitated between the end-user and the point of contact at the determined other address when the end-user selects the link to the determined other address.

24. The apparatus of claim 23 wherein the contact information is an alphanumeric name and an address and the determined other address is at least one of a telephone number, an email address, an SIP address, and an Instant Messaging address.

25. The apparatus of claim 23 wherein the means for determining from the contact information at least one address sends the located contact information in a request to a directory service server to determine the other address.

26. The apparatus of claim 19 wherein the apparatus is within a Web intermediary.
